(19) United States
(12) Patent Application Publication
(10) Pub. No.: US 2010/0152022 A1
(43) Pub. Date: Jun. 17, 2010

(54) Catalyst regeneration method

(76) Inventors: Qi Sun, West Chester, PA (US); George B. Nowowiejski, Houston, TX (US)

Correspondence Address: LyondellBasell Industries, 3801 WEST CHESTER PIKE, NEWTOWN SQUARE, PA, 19073, US

(21) Appl. No.: 12/316,829

(22) Filed: Dec. 17, 2008

(51) Int. Cl. B01J 20/34

(52) U.S. Cl. 502/53; 502/34; 502/55

(57) ABSTRACT

A process is disclosed for regenerating a used catalyst comprising two or more noble metals supported on a carrier. The method comprises calcining a used catalyst comprising a noble metal and a transition metal supported on an inorganic carrier in an oxygen-containing gas to produce a calcined catalyst; and contacting the calcined catalyst with a hydrogen-containing gas at a temperature higher than 430° C.

### FIELD OF THE INVENTION

The invention relates to a method of regenerating a heterogeneous catalyst. The catalyst comprises a noble metal and a transition metal supported on an inorganic carrier.

### BACKGROUND OF THE INVENTION

Majority of industrial chemical reactions are catalytic processes. Many of these use heterogeneous catalysts. These catalysts tend to deactivate with time. There are many paths for a heterogeneous catalyst to deactivate. For example, a catalyst may be poisoned by one or more contaminants present in the feed. Its surface, pores, and voids may be fouled by carbon (coke) or other heavy organic molecules produced by chemical reactions. If the catalytic reaction is conducted at high temperatures, thermal degradation may occur in the form of active phase crystallite growth (e.g., metal sintering), collapse of the carrier pore structure, and/or solid-state reactions of the active phase (e.g., a metal oxide) with the carrier. In addition, the presence of chemical components in the feed (e.g., oxygen, chlorine) may lead to formation of volatile or soluble metal compounds, which can cause the leaching of the active component from a catalyst.

Supported noble metal catalysts are well known and are used in many chemical reactions, such as hydrogenation, dehydrogenation, oxidation, hydrocracking, isomerization, desulfurization, alkylation, cracking, hydroisomerization, and the like.

Methods for regenerating (reactivating) these catalysts are known. Some of these methods involve treating the catalyst by hydrogen.

U.S. Pat. No. 5,488,024 teaches a regeneration method of a palladium/silver-containing catalyst selective hydrogenation of acetylene. The regeneration method comprises heating the catalyst in air at a temperature which preferably does not exceed about 700° C. to burn off any organic matter and/or char that has been accumulated on the catalyst composition. Optionally, the oxidatively regenerated composition is reduced with hydrogen or a suitable hydrocarbon generally at a temperature in the range of about 30 to about 100° C. before its redeployment in the selective hydrogenation of acetylene.

U.S. Pat. No. 6,417,136 discloses a method for regenerating a catalyst comprising palladium, a metal aluminate catalyst carrier, and a component selected from the group consisting of silver and an alkali metal compound. The regeneration method comprises calcining the catalyst in an oxidizing atmosphere such as in air at a temperature that does not exceed about 700° C. to burn off carbonaceous and sulfur deposits. Optionally, the catalyst may be treated with a hydrogen containing fluid to activate the catalyst. The reductive, or activation, treatment can be carried out at a temperature generally in the range of from about 20° C. to about 200° C.

U.S. Pat. Appl. Pub. No. 2004/0024272 teaches a regeneration method of a supported palladium-silver catalyst comprising heating the catalyst in air, at a temperature which preferably does not exceed about 704° C. to burn off any organic matter and/or char that has been accumulated on the catalyst composition. Optionally, the oxidatively regenerated catalyst is reduced with hydrogen or a suitable hydrocarbon at a temperature in the range of about 1° C. to about 426° C., preferably about 93° C. to about 315° C., more preferably about 149° C. to about 260° C., and most preferably at about 204° C. for a time period of about 0.5 to about 20 hours before its redeployment in the selective hydrogenation of acetylene.

U.S. Pat. No. 7,256,149 teaches a method of regenerating a used noble metal-containing titanium zeolite catalyst comprising the steps of: (1) heating the used catalyst at a temperature of at least 250° C. in the presence of a gas stream comprised of oxygen to obtain a heated product; and (2) reducing the heated product at a temperature of at least 20° C. in the presence of a gas stream comprised of hydrogen to form a reactivated catalyst. The noble metal-containing titanium zeolite catalyst was used to catalyze the epoxidation of an olefin with hydrogen and oxygen in the presence of at least one reaction solvent and at least one buffer. The noble metal-containing titanium zeolite catalyst may comprise two or more noble metals.

### SUMMARY OF THE INVENTION

The invention is a regeneration method for a catalyst comprising a noble metal and a transition metal supported on an inorganic carrier. The method comprises calcining a used catalyst in an oxygen-containing gas to produce a calcined catalyst and then contacting the calcined catalyst in a hydrogen-containing gas at a temperature higher than 430° C.

### DETAILED DESCRIPTION OF THE INVENTION

In the present disclosure, the catalyst is a solid material that is used to catalyze a chemical process. Before the catalyst is used in the process, it is referred to as a fresh catalyst. After the catalyst is used in the process for a period of time, it is removed from the process as a used catalyst.

The catalyst comprises an inorganic carrier. Typically, it is preferred that the carrier is a porous and has a surface area of from about 1 to about 1000 m²/g. The carrier should be relatively refractory to the conditions utilized in the chemical process. Suitable carriers are: (1) inorganic oxide and mixed oxides such as alumina, silica or silica gel, titanium dioxide, zirconium dioxide, chromium oxide, zinc oxide, magnesia, boria, silica-alumina, silica-magnesia, chromia-alumina, alumina-boria, silica-zirconia, clays, diatomaceous earth, fuller's earth, kaolin, etc.; (2) ceramics, porcelain, crushed firebrick, and bauxite; (3) zeolites such as naturally occurring or synthetically prepared zeolites either in the hydrogen form or in a form which has been treated with cations; and, (4) combinations of members from these groups. The preferred carriers include silica, alumina, and zeolite. Aluminas are preferred carriers.

A transition metal zeolite may be used as the carrier of the catalyst. A transition metal zeolite (e.g., titanium zeolite, vanadium zeolite) is a crystalline material having a porous molecular sieve structure and containing a transition metal. Suitable transition metal zeolites for the present invention are described in U.S. Pat. No. 7,387,981.

The catalyst comprises a noble metal. Suitable noble metals include palladium, gold, silver, platinum, iridium, ruthenium, rhodium, osmium, rhenium, and mixtures thereof. Preferred noble metals are Pd, Pt, Au, Ag, and mixtures thereof. Typically, the amount of noble metal present in the catalyst will be in the range of from 0.005 to 20 weight percent (wt %), preferably 0.01 to 5 wt %. Catalysts comprising palladium are more preferred. Catalysts comprising 0.001 to 2 wt % palladium are particularly preferred.

The catalyst comprises a transition metal. A transition metal is a group 3-12 element. The first row of them is from Sc to Zn. Preferred transition metals are Pd, Pt, Au, Ag, Ni, Cu, Zn, Mn, Fe, Co, Pb, Ru, Rh, Re, Os, and mixtures thereof. More preferred transition metals are Pt, Au, Ag, Cu, Ru, Rh, Re, and mixtures thereof. Particularly preferred transition metals are Ag, Au, and mixtures thereof.

Typically, the amount of the transition metal present in the catalyst is in the range of from 0.01 to 20 wt %, preferably 0.1 to 5 wt %.

The transition metal on the catalyst is different from the noble metal. Thus the catalyst comprises at least two metals.

The manner in which the noble metal and the transition metal are added into the catalyst is not critical. For example, they may be supported on the carrier by impregnation, ion exchange, adsorption, precipitation, or the like. The noble metal and the transition metal may be added on the carrier in a single step or in separate steps.

There are no particular restrictions regarding the choice of the noble metal and the transition metal compounds or complexes used as the source of the metals in the preparation of the catalyst. Examples of suitable palladium compounds include palladium acetate, palladium bromide, palladium chloride, palladium iodide, palladium nitrate, tetraamine palladium nitrate, palladium oxide, palladium sulfate, and the like, and combinations thereof. The palladium can have any available oxidation state. When added to the carrier by impregnation from a solution, some of the compounds can be added from aqueous solutions, but others will require non-aqueous solvents such as alcohols, hydrocarbons, ethers, ketones, and the like, or a mixture of water and organic solvents. Similarly, suitable examples of silver compounds include silver nitrate, silver acetate, silver cyanide, and the like, and combinations thereof. Suitable examples of copper compounds include copper nitrate, copper acetate, copper chloride, copper sulfate, copper oxide, and the like, and combinations thereof.

After the noble metal and the transition metal are added on the carrier, the material is typically calcined, and optionally further treated in a reducing atmosphere.

The catalyst may be in any desired shape such as spheres, pills, cakes, extrudates, powders, granules, etc., and utilized in any desired size.

The catalyst may be applicable in many chemical reactions such as hydrogenation, dehydrogenation, oxidation (e.g., direct epoxidation), hydrocracking, isomerization, desulfurization, alkylation, cracking, hydroisomerization, and the like. For example, a catalyst comprising palladium and silver supported on an alumina is used for hydrogenation of highly unsaturated hydrocarbons such as alkynes and/or diolefins. See U.S. Pat. Nos. 4,484,015 and 5,510,550. A catalyst comprising palladium and platinum is useful in producing hydrogen peroxide from hydrogen and oxygen (U.S. Pat. No. 7,060,244). A catalyst comprising a noble metal, a transition metal, and a transition metal zeolite can be used to produce an epoxide from an olefin, hydrogen, and oxygen (U.S. Pat. Nos. 6,403,815 and 6,984,606). For example, propylene oxide may be produced from propylene.

The catalyst-regeneration method comprises calcining the used catalyst in an oxygen-containing gas. The oxygen concentration in the gas is not critical. It may be in the range of from 0.1 to 100 mole percent (mol %). Generally air or a mixture of oxygen and nitrogen is used. When necessary, a gas mixture containing low level of oxygen is used to reduce the exotherm during calcination and to prevent the so-called “hot spot.” In one preferred method, the used catalyst is treated in an inert gas (e.g., nitrogen, argon, etc) to pyrolyze the organic material before it is calcined in an oxygen-containing gas.

The oxygen-containing gas may comprise steam. For example, it may comprise 5 to 90 mol % steam. Preferably it comprises 10 to 50 mol % steam.

The used catalyst is optionally washed by a solvent to remove any soluble materials from the surface before is it calcined. Any solvent may be used as long as it can dissolve organic deposit from the catalyst. Suitable solvents include water, alcohol, ethers, ketones, nitriles, esters, amides, hydrocarbons, and halogenated hydrocarbons.

Generally the calcination temperature is in the range of from 350 to 1000° C., more preferably from 450 to 800° C. The calcination preferably takes place under conditions sufficient to assure relatively uniform temperature and uniform removal of coke and organic deposits.

The pressure at which the calcination is performed is not critical. Typically, it is carried out under atmospheric pressure.

The calcination may be carried out in a stationary furnace, a fixed-bed reactor, a rotary kiln, or a belt calciner. See A. B. Stiles, Catalyst Manufacture, Marcel Dekker (1983), pp. 51-57. A rotary kiln is a cylindrical vessel, inclined slightly to the horizontal, which is rotated slowly about its axis. The material to be processed is fed into the upper end of the cylinder. As the kiln rotates, material gradually moves down towards the lower end, and undergoes a certain amount of mixing. Hot gases pass along the kiln, sometimes in the same direction as the catalyst (co-current), but usually in the opposite direction (counter-current). In a belt claciner, the catalyst may be loaded onto a belt where it is spread out in a uniformly thin layer. The catalyst then moves with the belt through a heating zone where the temperature and the composition of the atmosphere are controlled.

The material obtained from the calcination step (calcined catalyst) generally contains less than 0.5 wt %, more preferably less than 0.1 wt % carbon.

The catalyst-regeneration method comprises contacting the calcined catalyst with a hydrogen-containing gas at a temperature higher than 430° C. (hydrogen treatment). Preferably the hydrogen treatment is performed at a temperature in the range of 450 to 550° C.

The hydrogen-containing gas typically comprises at least 0.1 mol % hydrogen. The balance gas is preferably an inert gas, such as helium, nitrogen, argon. Conveniently, a gas comprising 1 to 10 mol % hydrogen is used. The time period of the hydrogen treatment is not critical. Typically it lasts for 0.1 to 48 h.

The hydrogen treatment may be appropriately carried out in a stationary furnace, a fixed-bed reactor, a rotary kiln, a belt calciner, or the like.

### EXAMPLE 1

### Catalyst Regeneration (Hydrogen Treatment at 500° C.)

A fresh spherical catalyst containing 0.03 wt % Pd and 0.18 wt % Ag supported on alumina (average particle diameter about 4.0 mm) and having a surface area of 150 m²/g is used in catalytic selective acetylene hydrogenation of an ethylene stream in a fixed-bed reactor. The feed contains about 1 mol % acetylene. The reaction temperature is from 20 to 110° C. The pressure is at 200-350 psig. The gas hourly space velocity is 3000 to 9000 h⁻¹. The catalyst is periodically regenerated by air/steam calcination at about 500° C., followed by hydrogen activation at about 100 to about 120° C. After 6 years, the catalytic performance deteriorates to an unacceptable level. The catalyst is removed from the reactor as used catalyst.

A sample of the used catalyst (55 mL) is packed in a quartz tube reactor (1 inch ID). The catalyst is heated to 370° C. under nitrogen (up-flow, flow rate about 460 mL/min) for 6.5 h. The nitrogen is replaced with a mixture of air (up-flow, flow rate 460 mL/min) and steam (up-flow, flow rate 0.24 g/min). After air/steam treatment for 1 h at 370° C., the furnace temperature is raised to 500° C. The treatment continues for another 4 h at 500° C. The reactor is cooled down under air flow.

The calcined catalyst obtained from the above is repacked in a 2-inch ID tube reactor. The catalyst is treated by a gas mixture containing 5 mol % hydrogen in nitrogen at a flow rate of 420 mL/min. The temperature of the tube furnace is brought from 21° C. to 150° C. at a rate of 5° C./min. After the temperature is held for 1 h at 150° C., it is raised at a rate of 8° C./min to a temperature of 500° C. The catalyst is then treated at 500° C. for 24 h. A regenerated catalyst (Catalyst A) is obtained after it is cooled to room temperature under the same gas flow

### EXAMPLE 2

### Catalyst Testing

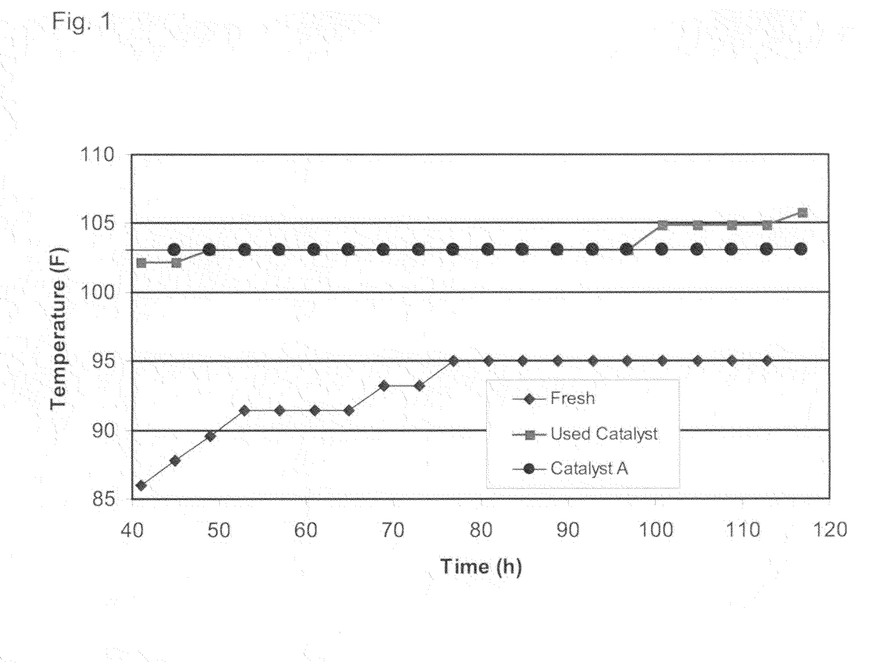

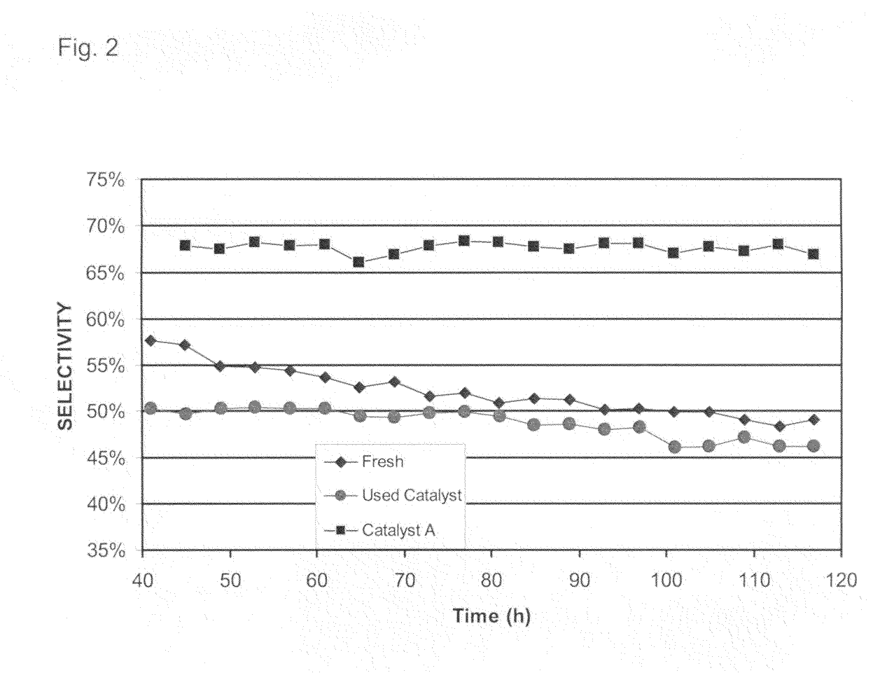

The same fresh catalyst as used in Example 1 is tested in a catalytic hydrogenation of acetylene in a fixed-bed reactor. The fresh catalyst (15 mL) is charged into a tubular reactor (ID 0.75 inch). The feed is a mixture of ethylene with 1 mol % acetylene and 1.3 mol % hydrogen. The pressure is at 300 psig. The gas hourly space velocity is at 3000 h⁻¹. The reaction temperature is adjusted so the acetylene conversion is maintained at about 70%. The average temperature of the bed as a function of the reaction time is shown in FIG. 1. The selectivities to ethylene for the hydrogenation of acetylene are shown in FIG. 2.

The testing procedure is repeated except that the 15 mL of used catalyst (from Example 1) and regenerated catalyst (Catalyst A) is used respectively. The test results are shown in FIG. 1 and FIG. 2.

FIG. 1 shows that it requires much lower temperature to maintain 70% acetylene conversion when the fresh catalyst is used as compared to the used or Catalyst A, indicating that both the used catalyst and Catalyst A have lower activities than the fresh catalyst. Catalyst A gives lower catalyst activity at the beginning of the test, but its activity does not decrease as the reaction time and its activity exceeds the activity of the used catalyst after 90 h.

FIG. 2 shows that the used catalyst has lower selectivity to ethylene than the fresh catalyst. The selectivity of the fresh catalyst gradually declines with time. Surprisingly, Catalyst A gives much higher selectivity than either the used catalyst or the fresh catalyst. Higher ethylene selectivity is beneficial because ethylene is the desired product of the selective hydrogenation of acetylene.

1. A catalyst-regeneration method comprising (a) calcining a used catalyst comprising palladium and silver supported on an inorganic carrier in an oxygen-containing gas at a temperature of 350 to 1000° C. to produce a calcined catalyst; and (b) contacting the calcined catalyst with a hydrogen-containing gas at a temperature higher than 430° C.

2. The method of claim 1 wherein the used catalyst comprises 0.001 to 2 wt % palladium.

3. The method of claim 1 wherein the used catalyst comprises 0.1 to 5 wt % silver.

4. (canceled)

5. The method of claim 1 wherein step (b) is performed at a temperature in the range of 450 to 550° C.

6. The method of claim 1 wherein the oxygen-containing gas comprises 10 to 50 mol % steam.

7. The method of claim 1 wherein the hydrogen-containing gas comprise from 1.0 to 10 mole percent hydrogen

8. The method of claim 1 wherein the inorganic carrier is selected from the group consisting of silica, alumina, zeolite, and mixtures thereof.

9. The method of claim 1 wherein the inorganic carrier is alumina.

10. (canceled)

11. The method of claim 1 wherein the used catalyst is recovered from an acetylene hydrogenation process.

12. The method of claim 1 wherein the used catalyst is recovered from a process for making hydrogen peroxide from hydrogen and oxygen.

13. The method of claim 1 wherein the inorganic carrier is a transition metal zeolite.

14. The method of claim 13 wherein the used catalyst is recovered from a process for making an epoxide from an olefin, hydrogen, and oxygen.

15. The method of claim 14 wherein the olefin is propylene.
